(19) United States
(12) Patent Application Publication
(10) Pub. No.: US 2018/0341883 A1
(43) Pub. Date: Nov. 29, 2018

(54) INFORMATION PROCESSING APPARATUS, INFORMATION PROCESSING METHOD, AND NON-TRANSITORY COMPUTER-READABLE STORAGE MEDIUM

(71) Applicant: FUJITSU LIMITED, Kawasaki-shi (JP)

(72) Inventors: Soma Kuwabara, Numazu (JP); Naoki Gunji, Numazu (JP); Shigeki SUGIYAMA, Hamamatsu (JP)

(73) Assignee: FUJITSU LIMITED, Kawasaki-shi (JP)

(21) Appl. No.: 15/983,394

(22) Filed: May 18, 2018

(30) Foreign Application Priority Data
May 29, 2017 (JP) 2017-105651

(51) Int. Cl. G06Q 10/06

(52) U.S. Cl. CPC G06Q 10/0631

(57) ABSTRACT

An information processing apparatus including a memory, and a processor coupled to the memory and the processor configured to execute a process, the process including receiving a request for an approval process for a specified organization included in a plurality of organizations, the approval process corresponding to a specified approval event included in a plurality of approval events, executing approval process based on first information stored in a storage unit, the first information indicating a plurality of contents, for each of the plurality of organizations, to which each of the plurality of approval events correspond, and executing, after the approval process, a following approval process for a higher organization of the specified organization, indicated by second information stored in the second storage unit, based on the first information, the second information indicating a hierarchy relationship of the plurality of organizations.

### CROSS-REFERENCE TO RELATED APPLICATION

This application is based upon and claims the benefit of priority of the prior Japanese Patent Application No. 2017-105651, filed on May 29, 2017, the entire contents of which are incorporated herein by reference.

### FIELD

The embodiment discussed herein is related to an information processing apparatus, an information processing method, and a non-transitory computer-readable storage medium.

### BACKGROUND

Conventionally, a system in which any of organizations in a company can use a pay service over a network is known. In some cases, use of the service by the organization is desired to be approved by a responsible person of another organization in the company, and information on an approval flow specifying which organizations approve use of the service and in which order the approval process is performed by responsible persons is created.

For example, there is known a technique for requesting a user who is in charge of slip approval to approve a slip created on a work system according to an approval route based on an approval route management table in which the user who is in charge of slip approval is registered. Furthermore, for example, there is known a technique for deciding, from among users who belong to a group selected from among a plurality of groups to which a drafter belongs, a user corresponding to authority of an approval rule that corresponds to a document category of a document to be approved among approval rules for specifying an approving person with authority. Furthermore, for example, there is known a technique for transferring a document to a substituting person indicated by substituting person information in a case where flag information registered in association with document destination information indicates that substituting person information is active upon occurrence of a document flow.

Japanese Laid-open Patent Publication No. 2009-20636, Japanese Laid-open Patent Publication No. 2005-38145, and Japanese Laid-open Patent Publication No. 2000-123092 are examples of related art.

### SUMMARY

According to an aspect of the invention, an information processing apparatus including a memory, and a processor coupled to the memory and the processor configured to execute a process, the process including receiving a request for an approval process for a specified organization included in a plurality of organizations, the approval process corresponding to a specified approval event included in a plurality of approval events, executing approval process based on first information stored in a storage unit, the first information indicating a plurality of contents, for each of the plurality of organizations, to which each of the plurality of approval events correspond, and executing, after the approval process, a following approval process for a higher organization of the specified organization, indicated by second information stored in the second storage unit, based on the first information, the second information indicating a hierarchy relationship of the plurality of organizations.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an aspect of an information processing method according to an embodiment;

FIG. 2 is an explanatory view illustrating an example of an information processing system;

FIG. 3 is a block diagram illustrating an example of a hardware configuration of an information processing apparatus;

FIG. 4 is an explanatory view illustrating an example of contents stored in an organization table;

FIG. 5 is an explanatory view illustrating an example of contents stored in a user information table;

FIG. 6 is an explanatory view illustrating an example of contents stored in an approval process table;

FIG. 7 is an explanatory view illustrating setting patterns of an approval process table;

FIG. 8 is a block diagram illustrating an example of a functional configuration of the information processing apparatus;

FIG. 9 is an explanatory view illustrating generation of an approval application;

FIG. 10 is an explanatory view illustrating a specific example of an approval process table corresponding to a department;

FIG. 11 is an explanatory view illustrating a specific example of an approval process table corresponding to a division;

FIG. 12 is an explanatory view illustrating a specific example of an approval process table corresponding to a supervisory division;

FIG. 13 is an explanatory view illustrating a specific example of an approval process table corresponding to headquarters;

FIG. 14 is an explanatory view illustrating a specific example of an approval flow corresponding to project creation;

FIG. 15 is an explanatory view illustrating a specific example of an approval flow corresponding to registration for service use;

FIG. 16 is an explanatory view illustrating a specific example of an approval flow corresponding to service use;

FIG. 17 is an explanatory view illustrating a specific example of transmission of an approval request;

FIG. 18 is an explanatory view illustrating an example 1 of application of the information processing apparatus to a change of an organization structure;

FIG. 19 is an explanatory view illustrating an example 2 of application of the information processing apparatus to a change of an organization structure;

FIG. 20 is a sequence diagram illustrating a flow of an approval control process; and

FIG. 21 is a flowchart illustrating an example of a procedure of the approval control process.

### DESCRIPTION OF EMBODIMENT

However, according to the conventional arts, it is difficult to control which organizations in a company approve use of a service and in which order the approval process is performed by responsible persons of the organizations before the service is used by any of organizations in the company. For example, in a case where an administrator in the company creates approval flow information for each organization of the company in advance, the administrator creates the approval flow information for each organization again every time an organization structure is changed. This invites an increase in burden on the administrator.

An object of one aspect is to provide an information processing apparatus, an information processing method, and a non-transitory computer-readable storage medium that can easily control execution of an approval process of each of one or more organizations.

An information processing apparatus, an information processing method, and a non-transitory computer-readable storage medium according to the present embodiment is described below with reference to the drawings.

Aspect of information Processing Method According to Embodiment

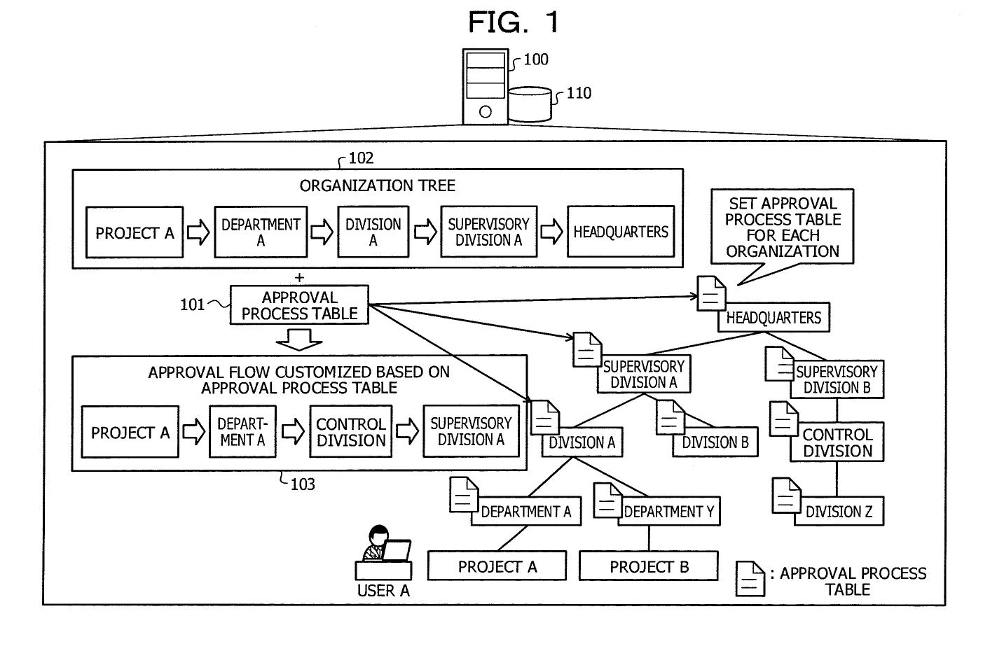

FIG. 1 is an explanatory view illustrating an aspect of an information processing method according to the embodiment. An information processing apparatus 100 is a computer that controls an approval process of a predetermined organization. The organization is, for example, a group in a company. The organization is, for example, a project, a department, or a division. The approval process is, for example, a process for determining whether or not to approve use of a service.

In recent years, there is a system in which each organization in a company can use a pay service over a network. In some cases, it is desired that a responsible person of a predetermined organization in the company approve use of the pay service before any of the organizations in the company uses the pay service over the network.

For example, in a case where any of the organizations in the company uses a metered rate service that offers use of a virtual machine in a data center over a network, it is sometimes requested that a usage fee in the whole company be kept equal to or lower than an upper limit. However, it is difficult for any of the organizations in the company to use the service while grasping a usage fee in the whole company.

In view of such a circumstance, it is sometimes desired that a control division in a company approve use of a service before use of the service by an organization in the company so that a usage fee in the whole company can be managed by the control division. Meanwhile, there is a hierarchical relationship among organizations in the company, and therefore it is sometimes desired that an organization superior to an organization that uses the service approve use of the service.

One method to meet this desire is to perform control so that an organization superior to an organization that uses the service approves use of the service by using information on the hierarchical relationship among the organizations in the company. However, the control division is not necessarily a highest-level organization, and it is therefore difficult for the control division to manage a usage fee in the whole company.

In another method, a user of a service in any of the organizations in the company determines in which order administrators of one or more organizations in the company approve use of the service and creates approval flow information. However, it is difficult for the control division to manage a usage fee in the whole company unless the user of the service creates the approval flow information so that a responsible person of the control division approves use of the service. Furthermore, the user of the service creates the approval flow information again while grasping the organization structure in the company every time an organization structure in the company changes. This invites an increase in burden on the user of the service. Furthermore, it is harder for the user of the service to create the approval flow information as the company scale becomes larger.

Alternatively, it may be possible to employ a method in which an administrator in the company determines, for each organization in the company, in which order administrators of one or more organizations in the company approve use of the service and creates approval flow information. However, it is difficult for the administrator creates the approval flow information again while grasping the organization structure in the company every time an organization structure in the company changes. This invites an increase in burden on the administrator. Furthermore, it is harder for the administrator to create the approval flow information as the company scale becomes larger and as the number of organizations using the service becomes larger.

Furthermore, in some cases, an approval policy concerning use of a service is decided in an organization of a company. For example, in some cases, an approval policy of automatically approving use of a service is decided so that burden on an administrator of the organization is lessened. However, it is sometimes hard for even an organization having the approval policy of automatically approving use of a service to follow the approval policy of the organization in a case where the organization is set as an organization that performs an approval process by a user of the service or an administrator in the company. It is therefore sometimes hard to flexibly put different approval policies in operation in organizations in the company.

In view of this, the present embodiment discusses an information processing method that can easily control an approval process of each of one or more organizations in a company in consideration of a hierarchical relationship among organizations in the company and contents of control on an approval process of each of the organizations in the company.

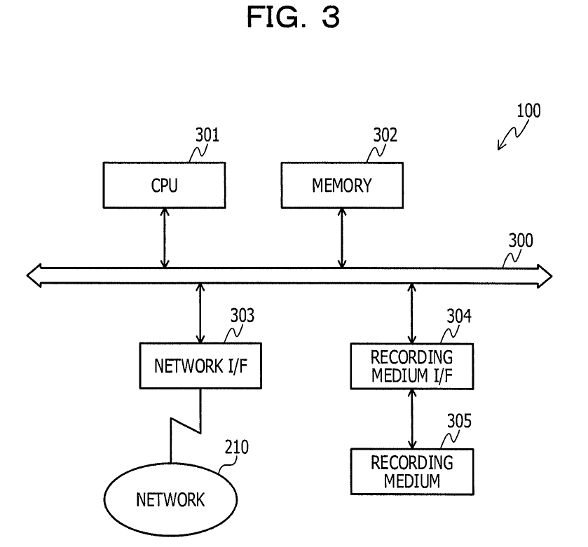

In the example illustrated in FIG. 1, the information processing apparatus 100 includes a storage unit 110. The storage unit 110 is, for example, storage regions such as a memory 302 and a recording medium 305 that will be described later with reference to FIG. 3. The storage unit 110 stores therein first information and second information in association with each of a plurality of organizations.

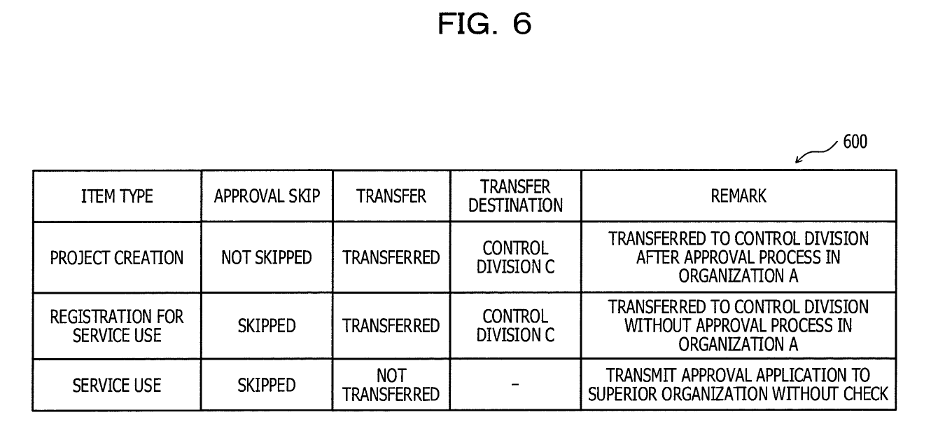

The first information of each of the organizations is information indicative of contents of control on an approval process of the organization. Contents of control on an approval process of an organization are, for example, contents of a control process for controlling execution of an approval process of the organization. The first information of each of the organizations is, for example, an approval process table 101 set for the organization. The approval process table 101 includes contents of a control process on an approval process of an organization and includes, for example, contents of control of skipping an approval process of the organization. The skip means automatic approval. An example of contents stored in the approval process table 101 will be described later, for example, with reference to FIG. 6. The first information of any of the organizations may sometimes include contents of control on an approval process of another organization different from the organization. Contents of control on an approval process of another organization are, for example, contents of a control process for controlling execution of an approval process of the other organization.

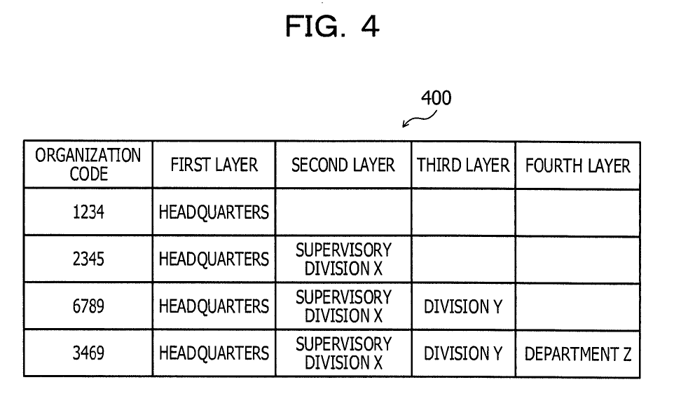

The second information of each of the organizations is information indicative of an organization whose approval process is controlled next to the organization. The second information of each of the organizations is, for example, information indicative of an organization that is directly superior to the organization on an organization tree indicative of a hierarchical relationship among the organizations. The second information of each of the organizations is collectively stored, for example, as information 102 on the organization tree. Specifically, the second information of each of the organizations is collectively stored by using an organization table. An example of contents stored in the organization table will be described later with reference to FIG. 4.

Upon receipt of an approval application, the information processing apparatus 100 sequentially controls an approval process of each of one or more organizations among a plurality of organizations based on contents stored in the storage unit 110. Control of an approval process of an organization corresponds, for example, to execution of a control process for controlling execution of the approval process of the organization. For example, upon receipt of an approval application to any of the organizations, the information processing apparatus 100 controls an approval process of the organization in accordance with contents of control on the approval process of the organization. Then, the information processing apparatus 100 repeats control of an approval process of an organization whose approval process is controlled next to the last organization whose approval process is controlled in a case where the organization whose approval process is controlled next to the last organization is present.

Specifically, the information processing apparatus 100 can control execution of an approval process of each of organizations such as a project A, a department A, a division A, a control division, a supervisory division A, and headquarters so that an approval flow 103 is realized, without creating information on the approval flow 103. According to the approval flow 103, an approval process of the project A is executed, an approval process of the department A is executed, an approval process of the division A is skipped, an approval process of the control division is executed regardless of the hierarchical relationship among the organizations, an approval process of the supervisory division A is executed, and an approval process of the headquarters is skipped.

In this way, the information processing apparatus 100 can easily realize various approval flows by specifying how to control execution of an approval process of each of the organizations without creating information on an approval flow for each organization using a service. Accordingly, the information processing apparatus 100 can easily control execution of an approval process of each of the organizations, easily manage execution of an approval process of each of the organizations, and easily cope with a change of an organization structure.

For example, even in a case where an organization structure changes as a result of addition of a new organization, the information processing apparatus 100 may not change contents of control on an approval process of an organization for which a directly superior organization has not been changed. Therefore, the information processing apparatus 100 can easily control execution of an approval process of each of the organizations and easily manage execution of an approval process of each of the organizations in accordance with a change of an organization structure.

Furthermore, the information processing apparatus 100 can keep an increase in burden on a user of a service small since the user of the service may not create information on an approval flow.

Furthermore, the information processing apparatus 100 can control a predetermined organization to execute an approval process regardless of the hierarchical relationship among the organizations. The information processing apparatus 100 allows, for example, the control division to easily manage the organizations regardless of the hierarchical relationship among the organizations.

Furthermore, since how to control execution of an approval process is specified for each organization, the information processing apparatus 100 can flexibly cope with different approval policies of the organizations even in a case where an approval policy differs from one organization to another.

Example of Information Processing System 200

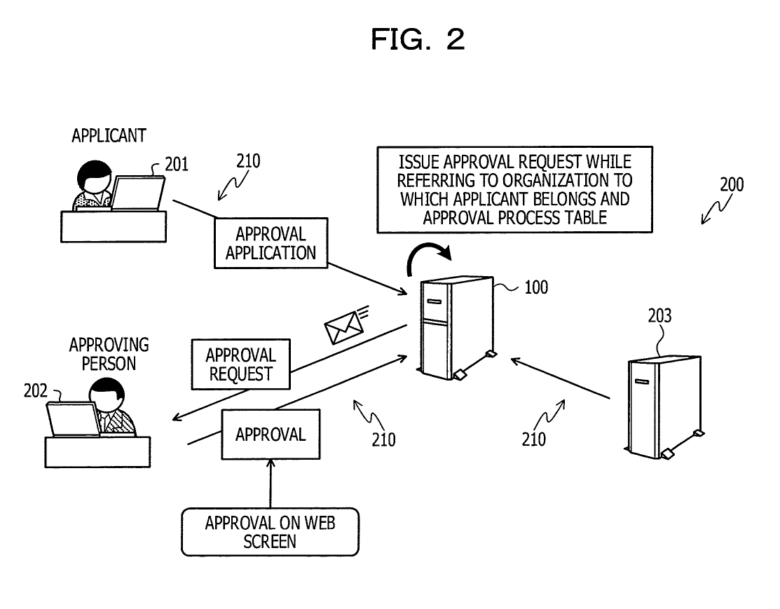

Next, an example of an information processing system 200 to which the information processing apparatus 100 illustrated in FIG. 1 is applied is described with reference to FIG. 2.

FIG. 2 is an explanatory view illustrating an example of the information processing system 200. In FIG. 2, the information processing system 200 includes the information processing apparatus 100, an apparatus for request 201, an apparatus for approval 202, and an information accumulation apparatus 203.

In the information processing system 200, the information processing apparatus 100, the apparatus for request 201, the apparatus for approval 202, and the information accumulation apparatus 203 are connected over a wired or wireless network. The network is, for example, a local area network (LAN), a wide area network (WAN), or the Internet.

The apparatus for request 201 is a computer that is provided in any of the organizations and transmits an approval application to the information processing apparatus 100 upon receipt of applicant's input. The apparatus for request 201 is, for example, a personal computer (PC), a tablet terminal, or a smartphone.

The information processing apparatus 100 is a computer that sequentially controls, upon receipt of the approval application, execution of an approval process of each of one or more organizations based on an organization to which the applicant belongs while referring to various tables that will be described later with reference to FIGS. 4 through 6. For example, the information processing apparatus 100 transmits an approval request to the apparatus for approval 202 provided in each of the one or more organizations. The information processing apparatus 100 is, for example, a server or a PC.

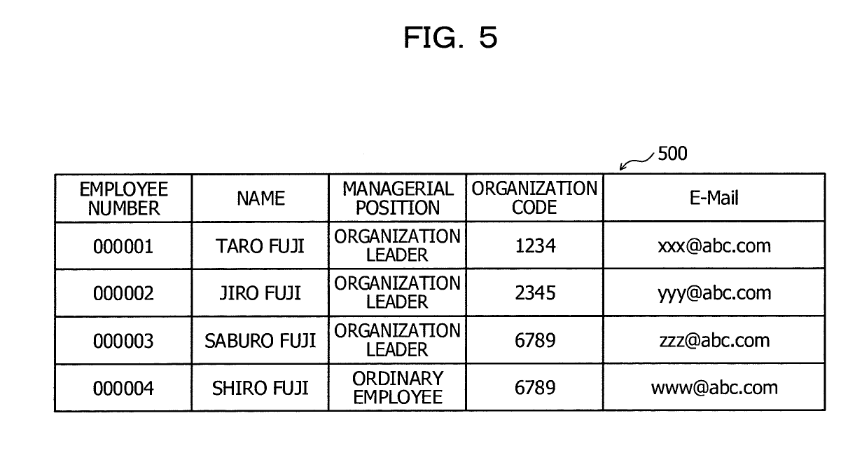

The information accumulation apparatus 203 is a computer that stores therein an organization table 400 that will be described later with reference to FIG. 4, a user information table 500 that will be described later with reference to FIG. 5, and the like and offers the organization table 400, the user information table 500, and the like to the information processing apparatus 100. The information accumulation apparatus 203 is, for example, a server or a PC.

The apparatus for approval 202 is a computer that is provided in any of the organizations and receives the approval request from the information processing apparatus 100. The apparatus for approval 202 transmits an approval result to the information processing apparatus 100 upon receipt of approving person's input. The apparatus for approval 202 may manage an approval process table 600 and the like that will be described later with reference to FIG. 6 that corresponds to the organization in which the apparatus for approval 202 is provided and offer the approval process table 600 and the like to the information processing apparatus 100 upon receipt of approving person's input. The apparatus for approval 202 is, for example, a PC, a tablet terminal, or a smartphone.

Although a case where the information processing apparatus 100 is different from the information accumulation apparatus 203 has been described above, the present embodiment is not limited to this. For example, the information processing apparatus 100 may function as the information accumulation apparatus 203, in other words, may be integral with the information accumulation apparatus 203. In this case, specifically, the information processing system 200 may not include the information accumulation apparatus 203.

Although a case where the apparatus for request 201 is different from the apparatus for approval 202, the present embodiment is not limited to this. For example, the apparatus for request 201 may function as the apparatus for approval 202, in other words, may be integral with the apparatus for approval 202. In this case, specifically, a computer that functions as both of the apparatus for request 201 and the apparatus for approval 202 is provided in each of the organizations.

Example of Hardware Configuration of Information Processing Apparatus 100

Next, an example of a hardware configuration of the information processing apparatus 100 is described with reference to FIG. 3.

FIG. 3 is a block diagram illustrating an example of a hardware configuration of the information processing apparatus 100. In FIG. 3, the information processing apparatus 100 includes a central processing unit (CPU) 301, the memory 302, a network interface (I/F) 303, a recording medium I/F 304, and the recording medium 305. These constituent elements are connected through a bus 300.

The CPU 301 controls the whole information processing apparatus 100. The memory 302 has, for example, a read only memory (ROM), a random access memory (RAM), and a flash ROM. Specifically, for example, the flash ROM and the ROM store various programs therein, and the RAM is used as a work area for the CPU 301. The programs stored in the memory 302 are loaded into the CPU 301, and thus coded processes are performed by the CPU 301.

The network I/F 303 is connected to the network 210 through a communication line and is connected to another computer over the network 210. The network I/F 303 serves as an interface between the network 210 and an inside and controls data input and output from another computer. As the network I/F 303, a modem, a LAN adapter, or the like can be used.

The recording medium I/F 304 controls reading and writing of data from and into the recording medium 305 under control of the CPU 301. The recording medium I/F 304 is, for example, a disc drive, a solid state drive (SSD), or a universal serial bus (USB) port. The recording medium 305 is a non-volatile memory in which data written under control of the recording medium I/F 304 is stored. The recording medium 305 is, for example, a disc, a semiconductor memory, or a USB memory. The recording medium 305 may be attachable to and detachable from the information processing apparatus 100.

The information processing apparatus 100 may have a keyboard, a mouse, a display, a printer, a scanner, a microphone, a speaker, and the like in addition to the above constituent elements. The information processing apparatus 100 may be configured not to have the recording medium I/F 304 and the recording medium 305.

Example of Hardware Configuration of Apparatus for Request 201

An example of a hardware configuration of the apparatus for request 201 is, for example, similar to the example of the hardware configuration of the information processing apparatus 100 illustrated in FIG. 3, and therefore description thereof is omitted.

Example of Hardware Configuration of Apparatus For Approval 202

An example of a hardware configuration of the apparatus for approval 202 is, for example, similar to the example of the hardware configuration of the information processing apparatus 100 illustrated in FIG. 3, and therefore description thereof is omitted.

Example of Hardware Configuration of Information Accumulation Apparatus 203

An example of a hardware configuration of the information accumulation apparatus 203 is, for example, similar to the example of the hardware configuration of the information processing apparatus 100 illustrated in FIG. 3, and therefore description thereof is omitted.

Contents Stored in Organization Table 400

Next, contents stored in the organization table 400 are described with reference to FIG. 4. For example, the organization table 400 is acquired from the information accumulation apparatus 203 by the information processing apparatus 100 and is realized by storage regions such as the memory 302 and the recording medium 305 of the information processing apparatus 100 illustrated in FIG. 3.

FIG. 4 is an explanatory view illustrating an example of contents stored in the organization table 400. As illustrated in FIG. 4, the organization table 400 includes fields for an organization code, a first layer, a second layer, a third layer, and a fourth layer. In the organization table 400, information is set in each field for each organization, and thus information indicative of an organization tree is stored as a record.

In the organization code field, an organization code for specifying an organization is set. In the first layer field, a name for specifying an organization in the first layer is set. For example, the first layer field indicates that an organization specified by the organization code is an organization itself in the first layer specified by the set name or an organization subordinate to the organization in the first layer. In the first layer field, a name for specifying an organization that corresponds to headquarters, which is the highest level, is set, and, for example, “headquarters” is set.

In the second layer field, a name for specifying an organization in the second layer is set. For example, the second layer field indicates that an organization specified by the organization code is an organization itself in the second layer specified by the set name or an organization subordinate to the organization in the second layer. In the second layer field, a name for specifying an organization that corresponds to a business division, is set, and, for example, “supervisory division X” is set.

In the third layer field, a name for specifying an organization in the third layer is set. For example, the third layer field indicates that an organization specified by the organization code is an organization itself in the third layer specified by the set name or an organization subordinate to the organization in the third layer. In the third layer field, a name for specifying an organization that corresponds to a division, is set, and, for example, “division Y” is set.

In the fourth layer field, a name for specifying an organization in the fourth layer is set. For example, the fourth layer field indicates that an organization specified by the organization code is an organization itself in the fourth layer specified by the set name or an organization subordinate to the organization in the fourth layer. In the fourth layer field, a name for specifying an organization that corresponds to a department, is set, and, for example, “department Z” is set.

For example, in a case where an organization specified by an organization code “1234” is “headquarters”, “headquarters” is set in the first layer field, and no information is set in the second layer field, the third layer field, and the fourth layer field. This indicates that the headquarters is the highest level.

For example, in a case where an organization specified by an organization code “3469” is a “department Z”, “headquarters” is set in the first layer field, “supervisory division X” is set in the second layer field, “division Y” is set in the third layer field, and “department Z” is set in the fourth layer field. This indicates that the department Z is an organization subordinate to the division Y subordinate to the supervisory division X subordinate to the headquarters.

Contents Stored in User Information Table 500

Next, contents stored in the user information table 500 are described with reference to FIG. 5. For example, the user information table 500 is acquired from the information accumulation apparatus 203 by the information processing apparatus 100 and is realized by storage regions such as the memory 302 and the recording medium 305 of the information processing apparatus 100 illustrated in FIG. 3.

FIG. 5 is an explanatory view illustrating an example of contents stored in the user information table 500. As illustrated in FIG. 5, the user information table 500 have fields for an employee number, a name, a managerial position, an organization code, and an e-mail. In the user information table 500, information is set in each field for each approving person, and thus user information is stored as a record.

In the employee number field, an employee number for specifying an approving person is set. In the name field, a name of an approving person is set. In the managerial position field, a managerial position of an approving person is set. In the organization code field, an organization code for specifying an organization to which an approving person belongs is set. In the e-mail field, an e-mail indicative of a destination used when an approval request is transmitted to the apparatus for approval 202 used by an approving person is set.

Contents Stored in Approval Process Table 600

Next, contents stored in the approval process table 600 are described with reference to FIG. 6. The approval process table 600 is realized, for example, by storage regions such as the memory 302 and the recording medium 305 of the information processing apparatus 100 illustrated in FIG. 3.

FIG. 6 is an explanatory view illustrating an example of contents stored in the approval process table 600. As illustrated in FIG. 6, the approval process table 600 has fields for an item type, approval skip, transfer, a transfer destination, and a remark. In the approval process table 600, information is set in each field for each type of work to be approved, and thus approval process information is stored as a record.

In the item type field, a type of event to be approved is set. In the approval skip field, flag information indicative of whether or not to skip an approval process is set. In the transfer field, flag information indicative of whether or not to control an approval process of an organization set as a transfer destination is set. In the transfer field, for example, flag information indicative of whether or not to control execution of an approval process of an organization set as a transfer destination is set. Specifically, in the transfer field, flag information indicative of whether or not to control execution of an approval process of a control division C is set. In the transfer destination field, information for specifying an organization set as a transfer destination is set. In the transfer destination field, for example, the control division C is set. In the remark field, contents indicating which organization executes an approval process and how a record controls execution of the approval process are set.

Setting Patterns of Approval Process Table 600

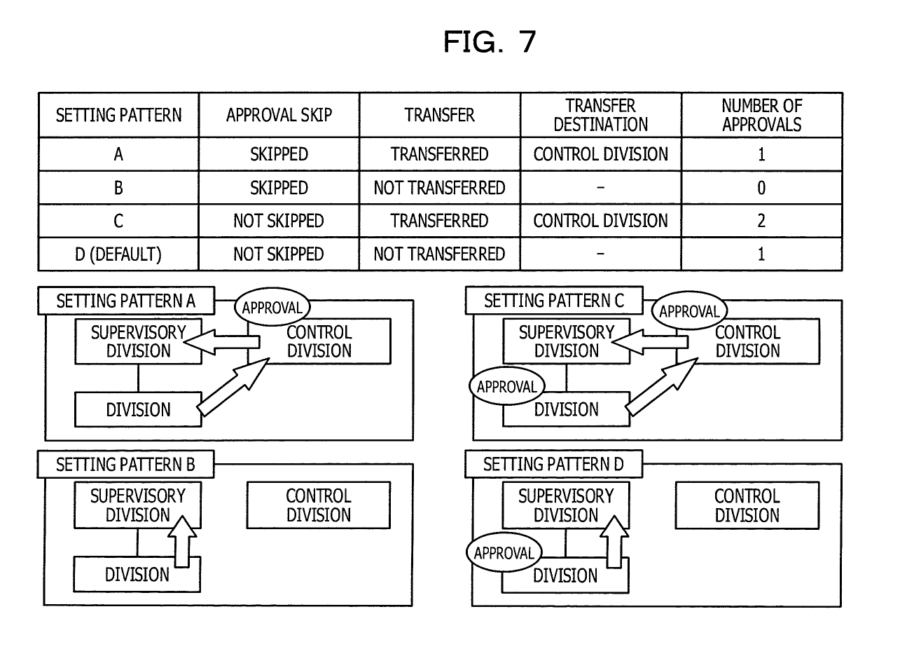

Next, setting patterns of the approval process table 600 are described with reference to FIG. 7.

FIG. 7 is an explanatory view illustrating setting patterns of the approval process table 600. In the approval process table 600, information is set in fields for approval skip, transfer, and a transfer destination, and for example, a setting pattern A, a setting pattern B, a setting pattern C, and a setting pattern D are created.

In the setting pattern A, “skipped”, “transferred”, and “control division” are set in the approval skip field, transfer field, and transfer destination field, respectively, in the approval process table 600. For example, a case where the setting pattern A is set in the approval process table 600 corresponding to a division subordinate to the supervisory division is taken as an example. In this case, the information processing apparatus 100 performs control so that an approval process of the division is skipped and an approval process of the control division is executed, and then proceeds to control of the supervisory division. In the setting pattern A, an approval process is executed one time in total.

In the setting pattern B, “skipped”, “not transferred”, and “-” are set in the approval skip field, transfer field, and transfer destination field, respectively, in the approval process table 600. For example, a case where the setting pattern B is set in the approval process table 600 corresponding to a division subordinate to the supervisory division is taken as an example. In this case, the information processing apparatus 100 controls so that an approval process of the division is skipped and then proceeds to control of the supervisory division. In the setting pattern B, an approval process is executed 0 time in total.

In the setting pattern C, “not skipped”, “transferred”, and “control division” are set in the approval skip field, transfer field, and transfer destination field, respectively, in the approval process table 600. For example, a case where the setting pattern C is set in the approval process table 600 corresponding to a division subordinate to the supervisory division is taken as an example. In this case, the information processing apparatus 100 performs control so that an approval process of the division is executed and an approval process of the control division is executed, and then proceeds to control of the supervisory division. In the setting pattern C, an approval process is executed two times in total.

In the setting pattern D, “not skipped”, “not transferred”, and “-” are set in the approval skip field, transfer field, and transfer destination field, respectively, in the approval process table 600. For example, a case where the setting pattern D is set in the approval process table 600 corresponding to a division subordinate to the supervisory division is taken as an example. In this case, the information processing apparatus 100 performs control so that an approval process of the division is executed, and then proceeds to control of the supervisory division. In the setting pattern D, an approval process is executed one time in total. In this way, the information processing apparatus 100 can determine whether or not to execute an approval process of each organization in accordance with a setting pattern of the approval process table 600.

Example of Functional Configuration of Information Processing Apparatus 100

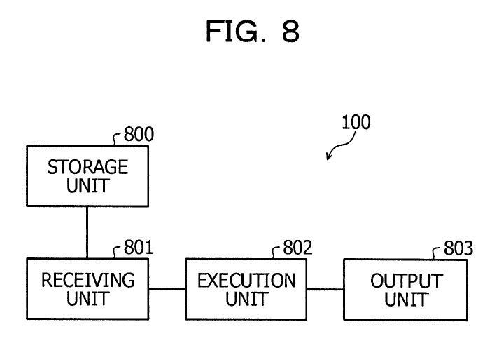

Next, an example of a functional configuration of the information processing apparatus 100 is described with reference to FIG. 8.

FIG. 8 is a block diagram illustrating an example of a functional configuration of the information processing apparatus 100. The information processing apparatus 100 includes a storage unit 800, a receiving unit 801, an execution unit 802, and an output unit 803.

The storage unit 800 is constituted, for example, by storage regions such as the memory 302 and the recording medium 305 illustrated in FIG. 3. The receiving unit 801, the execution unit 802, and the output unit 803 serve as a control unit. Specifically, functions of the receiving unit 801, the execution unit 802, and the output unit 803 are accomplished, for example, by execution, by the CPU 301, of programs stored in the storage regions such as the memory 302 and the recording medium 305 illustrated in FIG. 3 or by the network I/F 303. A result of processing in each functional unit is stored, for example, in the storage regions such as the memory 302 and the recording medium 305 illustrated in FIG. 3.

The storage unit 800 stores therein first information and second information in association with each of a plurality of organizations. There is a hierarchical relationship among the plurality of organizations. The first information of each of the organizations is information indicative of contents of control on an approval process of the organization. The first information of each of the organizations is, for example, information indicative of contents of a control process for controlling execution of an approval process of the organization. The second information of each of the organizations is information indicative of an organization whose approval process is controlled next to the organization. The second information of each of the organizations is, for example, information indicative of an organization that is subject to a control process for controlling execution of an approval process next to the organization. Specifically, the second information of each of the organizations is information indicative of an organization that is directly superior to the organization on an organization tree indicative of the hierarchical relationship among the organizations. Therefore, the storage unit 800 can specify how to control execution of an approval process of each of the organizations.

The storage unit 800 may store therein, for each type of an approval target, first information and second information in association with each of the organizations. The first information of each of the organizations for each type is information indicative of contents of control on an approval process of the organization for approving an approval target of the type. The first information of each of the organizations for each type is, for example, information indicative of contents of a control process for controlling execution of an approval process of the organization for approving an approval target of the type. The approval target is some sort of event. The approval target is, for example, project creation, registration for service use, or service use. Therefore, the storage unit 800 can specify how to control execution of an approval process of each of the organizations for each type of approval target.

First information indicative of contents of control on an approval process of any of the organizations may further include contents of control on an approval process of another organization that manages the approval process of the organization and that is different from the plurality of organizations. First information indicative of contents of control on an approval process of any of the organizations further includes, for example, contents of a control process for controlling execution of an approval process of another organization that manages the approval process of the organization and that is different from the plurality of organizations. The contents of control on the approval process of the other organization are realized, for example, by a transfer field and a transfer destination field of an approval process table. Therefore, the storage unit 800 can specify another organization that executes an approval process regardless of the hierarchical relationship.

First information indicative of contents of control on an approval process of any of the organizations may indicate contents of control of omitting execution of the approval process of the organization. The omission is realized by automatic approval. Contents of control of omitting execution of an approval process of any of the organizations are realized, for example, by an approval skip field of an approval process table. Therefore, the storage unit 800 allows the execution unit 802 to determine which of the organizations is an organization for which execution of an approval process is omitted.

The receiving unit 801 receives an approval application. The receiving unit 801 receives, for example, an approval application generated for any of the plurality of organizations. The approval application generated for any of the organizations is an approval application for requesting the any of the organizations to execute an approval process first. The approval application may indicate a type of approval target. The receiving unit 801 thus obtains a trigger for start of an operation of the execution unit 802. Furthermore, the receiving unit 801 can specify an organization whose approval process is controlled first and specify a type of approval target.

The execution unit 802 sequentially controls an approval process of each of one or more organizations among the plurality of organizations based on contents stored in the storage unit 800 when the receiving unit 801 receives an approval application. Control of an approval process of an organization corresponds to execution of a control process for controlling execution of the approval process of the organization. In this way, the execution unit 802 can easily control execution of an approval process of each of the organizations and easily manage execution of an approval process of each of the organizations.

For example, the execution unit 802 controls at least an approval process of any of the organizations based on contents stored in the storage unit 800. The execution unit 802 repeats control of an approval process of an organization whose approval process is controlled next to the last organization whose approval process is controlled in a case where the organization whose approval process is controlled next to the last organization exists. In this way, the execution unit 802 can easily sequentially control execution of an approval process from an organization to which the approval application is transmitted first to a highest-level organization.

For example, in a case where the execution unit 802 controls an approval process of any of the organizations based on contents stored in the storage unit 800, the execution unit 802 may further control an approval process of another organization. Control of an approval process of another organization corresponds to execution of a control process for controlling execution of the approval process of the other organization. The execution unit 802 can thus control execution of an approval process of another organization different from the plurality of organizations having a hierarchical relationship regardless of the hierarchical relationship among the organizations.

For example, the execution unit 802 may sequentially control an approval process of each of one or more organizations among the plurality of organizations based on first information and second information that are stored in the storage unit 800 and that correspond to the type indicated by the approval application. The execution unit 802 can thus switch how to control execution of an approval process of each of the organizations depending on the type of approval target.

The output unit 803 outputs a result of execution of an approval process of each of one or more organizations among the plurality of organizations. A form of the output is, for example, display on a display, print output to a printer, transmission to an external apparatus through the network I/F 303, or storage in a storage region such as the memory 302 or the recording medium 305. The output unit 803 may output a result of processing of each functional unit. In this way, the output unit 803 allows a user of the information processing apparatus 100 to grasp a result of execution of an approval process of each of the organizations, a result of processing of each functional unit, and the like.

Example of Control of Information Processing Apparatus 100 on Execution of Approval Process

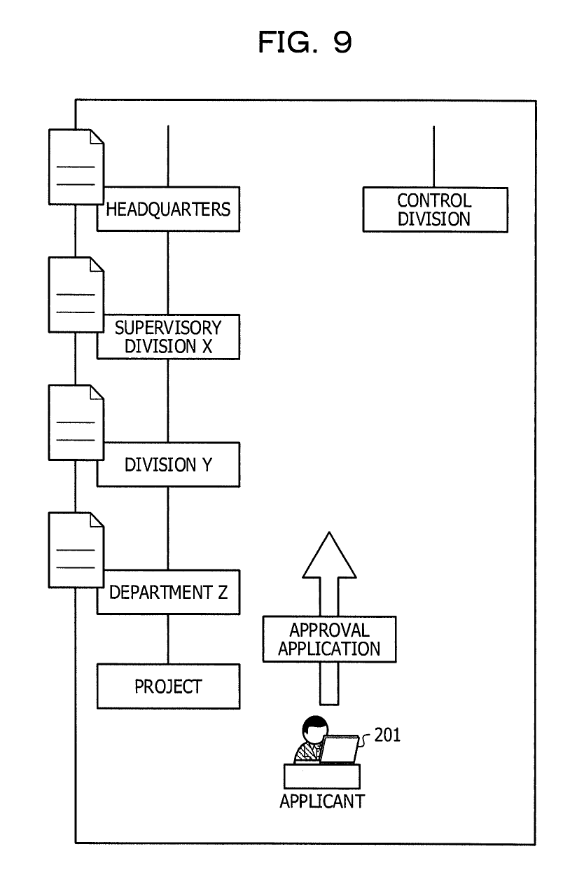

Next, an example of control of the information processing apparatus 100 on execution of an approval process is described with reference to FIGS. 9 through 17.

FIG. 9 is an explanatory view illustrating generation of an approval application. In the example illustrated in FIG. 9, the headquarters, the supervisory division X, the division Y, the department Z, the project, and the control division exist. The supervisory division X is directly subordinate to the headquarters. The division Y is directly subordinate to the supervisory division X. The department Z is directly subordinate to the division Y. The project is directly subordinate to the department Z. There is no hierarchical relationship between the control division and the headquarters, supervisory division X, division Y, department Z, and project.

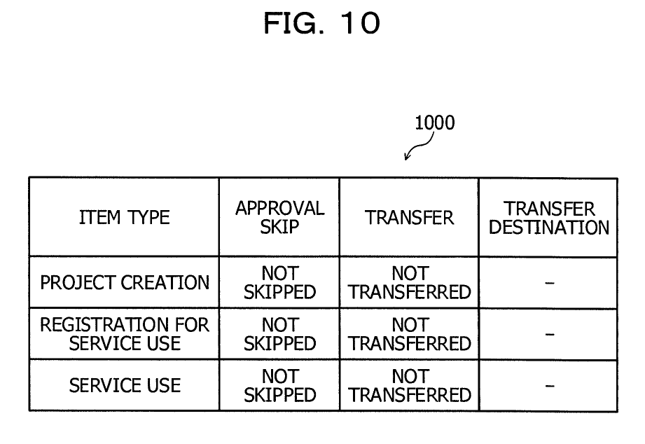

An applicant belonging to the project issues an approval application for the department Z. Specifically, the applicant belonging to the project transmits an approval application for the department Z to the information processing apparatus 100 by using the apparatus for request 201. The following describes approval process tables that correspond to the headquarters, supervisory division X, division Y, and department Z with reference to FIGS. 10 through 13.

FIG. 10 is an explanatory view illustrating a specific example of an approval process table 1000 that corresponds to the department Z. The approval process table 1000 that corresponds to the department Z has a record in which an item type “project creation”, approval skip “not skipped”, and transfer “not transferred” are associated. The approval process table 1000 that corresponds to the department Z has a record in which an item type “registration for service use”, approval skip “not skipped”, and transfer “not transferred” are associated. The approval process table 1000 that corresponds to the department Z has a record in which an item type “service use”, approval skip “not skipped”, and transfer “not transferred” are associated.

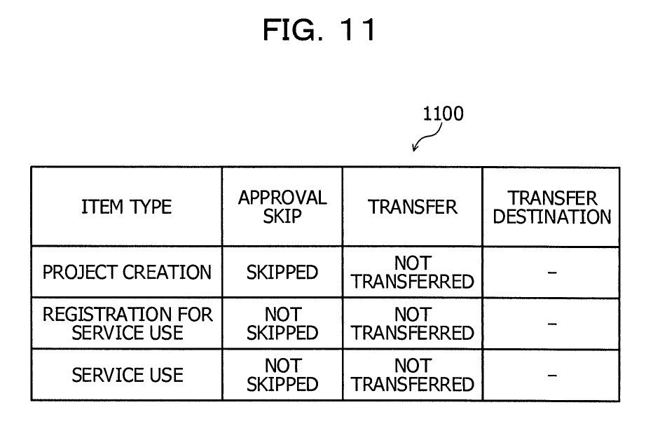

FIG. 11 is an explanatory view illustrating a specific example of an approval process table 1100 that corresponds to the division Y. The approval process table 1100 that corresponds to the division Y has a record in which an item type “project creation”, approval skip “skipped”, and transfer “not transferred” are associated. The approval process table 1100 that corresponds to the division Y has a record in which an item type “registration for service use”, approval skip “not skipped”, and transfer “not transferred” are associated. The approval process table 1100 that corresponds to the division Y has a record in which an item type “service use”, approval skip “not skipped”, and transfer “not transferred” are associated.

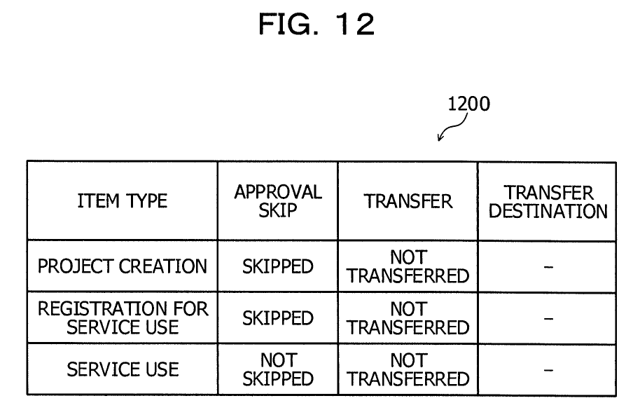

FIG. 12 is an explanatory view illustrating a specific example of an approval process table 1200 that corresponds to the supervisory division X. The approval process table 1200 that corresponds to the supervisory division X has a record in which an item type “project creation”, approval skip “skipped”, and transfer “not transferred” are associated. The approval process table 1200 that corresponds to the supervisory division X has a record in which an item type “registration for service use”, approval skip “skipped”, and transfer “not transferred” are associated. The approval process table 1200 that corresponds to the supervisory division X has a record in which an item type “service use”, approval skip “not skipped”, and transfer “not transferred” are associated.

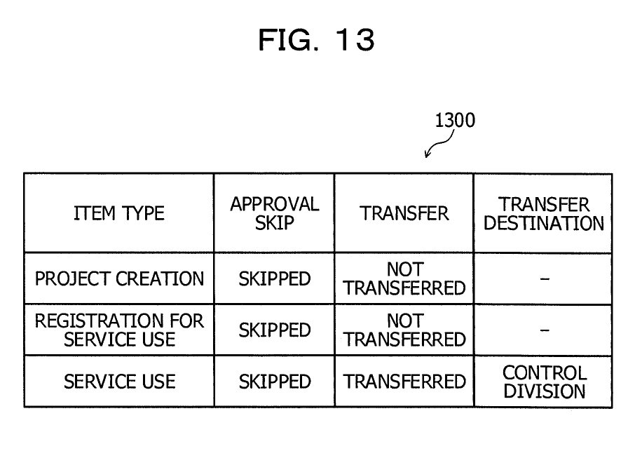

FIG. 13 is an explanatory view illustrating a specific example of an approval process table 1300 that corresponds to the headquarters. The approval process table 1300 that corresponds to the headquarters has a record in which an item type “project creation”, approval skip “skipped”, and transfer “not transferred” are associated. The approval process table 1300 that corresponds to the headquarters has a record in which an item type “registration for service use”, approval skip “skipped”, and transfer “not transferred” are associated. The approval process table 1300 that corresponds to the headquarters has a record in which an item type “service use”, approval skip “skipped”, transfer “transferred”, and transfer destination “control division” are associated.

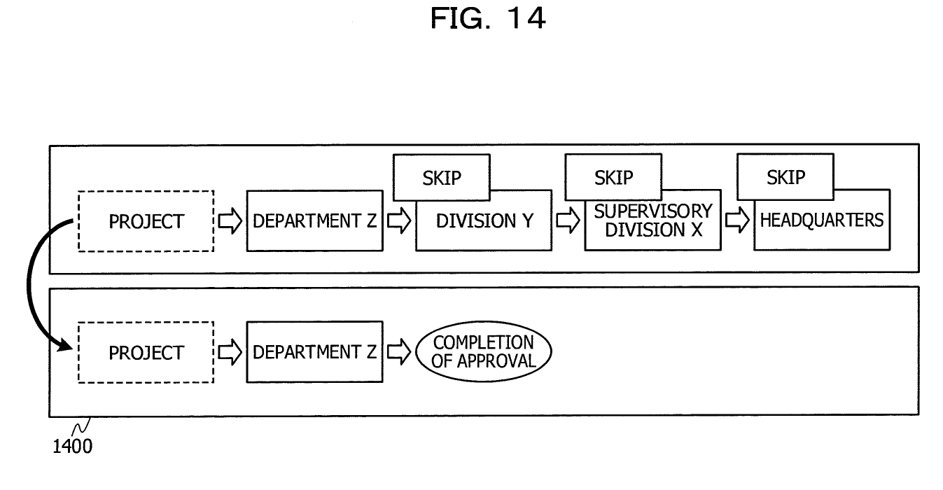

Next, how to control an approval process of each of the organizations by using approval process tables 1000 through 1300 illustrated in FIGS. 10 through 13 in a case where the information processing apparatus 100 receives an approval application illustrated in FIG. 9 is described with reference to FIGS. 14 through 16. First, FIG. 14 is described.

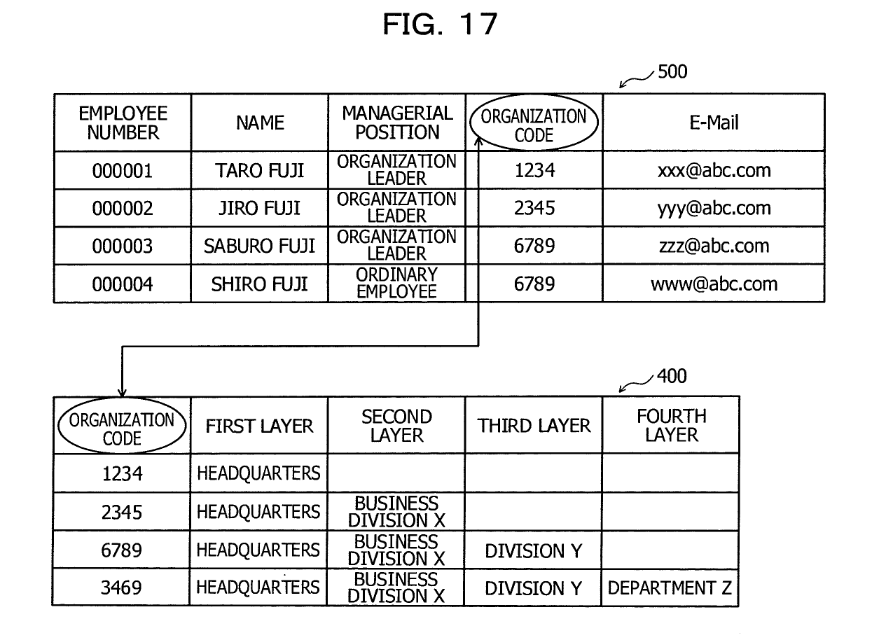

FIG. 14 is an explanatory view illustrating a specific example of an approval flow 1400 that corresponds to project creation. In FIG. 14, the information processing apparatus 100 determines that an approval process of the department Z is executed since the approval process table 1000 that corresponds to the department Z has a record in which an item type “project creation”, approval skip “not skipped”, and transfer “not transferred” are associated. The information processing apparatus 100 transmits an approval request to the apparatus for approval 202 of the department Z, causes an approving person of the department Z to determine whether or not to approve project creation, and receives an approval result. Transmission of an approval request will be described with reference to FIG. 17.

The information processing apparatus 100 determines that an approval process of the division Y is skipped since the approval process table 1100 that corresponds to the division Y has a record in which an item type “project creation”, approval skip “skipped”, and transfer “not transferred” are associated. The information processing apparatus 100 does not transmit an approval request to the apparatus for approval 202 of the division Y and assumes that an approval has been given automatically.

The information processing apparatus 100 determines that an approval process of the supervisory division X is skipped since the approval process table 1200 that corresponds to the supervisory division X has a record in which an item type “project creation”, approval skip “skipped”, and transfer “not transferred” are associated. The information processing apparatus 100 does not transmit an approval request to the apparatus for approval 202 of the supervisory division X and assumes that an approval has been given automatically.

The information processing apparatus 100 determines that an approval process of the headquarters is skipped since the approval process table 1300 that corresponds to the headquarters has a record in which an item type “project creation”, approval skip “skipped”, and transfer “not transferred” are associated. The information processing apparatus 100 does not transmit an approval request to the apparatus for approval 202 of the headquarters and assumes that an approval has been given automatically.

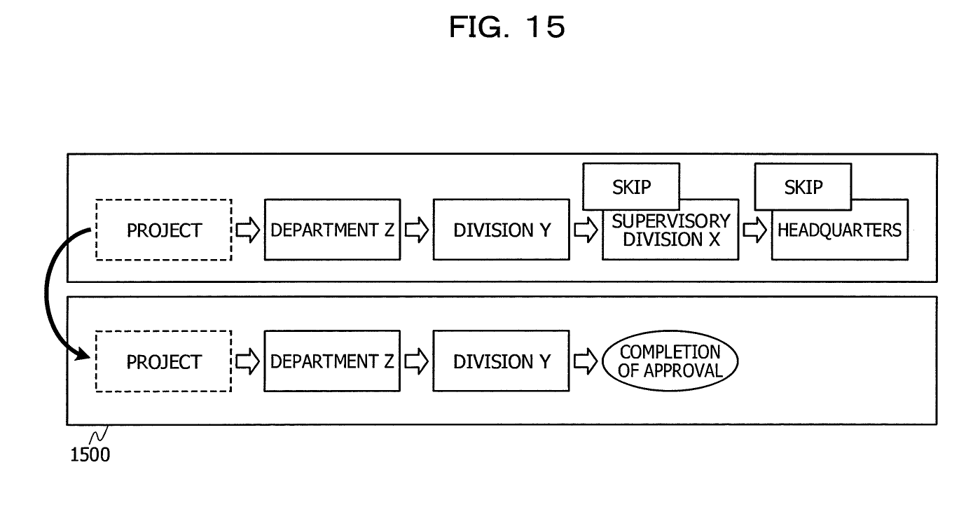

In this way, the information processing apparatus 100 can control an approval process of each of the organizations such as the department Z, the division Y, the supervisory division X, the headquarters, and the control division so that the approval flow 1400 is realized, without creating information indicative of the approval flow 1400. Next, FIG. 15 is described.

FIG. 15 is an explanatory view illustrating a specific example of an approval flow 1500 that corresponds to registration for service use. In FIG. 15, the information processing apparatus 100 determines that an approval process of the department Z is executed since the approval process table 1000 that corresponds to the department Z has a record in which an item type “registration for service use”, approval skip “not skipped”, and transfer “not transferred” are associated. The information processing apparatus 100 transmits an approval request to the apparatus for approval 202 of the department Z, causes an approving person of the department Z to determine whether or not to approve registration for service use, and receives an approval result.

The information processing apparatus 100 determines that an approval process of the division Y is executed since the approval process table 1100 that corresponds to the division Y has a record in which an item type “registration for service use”, approval skip “not skipped”, and transfer “not transferred” are associated. The information processing apparatus 100 transmits an approval request to the apparatus for approval 202 of the division Y, causes an approving person of the division Y to determine whether or not to approve registration for service use, and receives an approval result.

The information processing apparatus 100 determines that an approval process of the supervisory division X is skipped since the approval process table 1200 that corresponds to the supervisory division X has a record in which an item type “registration for service use”, approval skip “skipped”, and transfer “not transferred” are associated. The information processing apparatus 100 does not transmit an approval request to the apparatus for approval 202 of the supervisory division X and assumes that an approval has been given automatically.

The information processing apparatus 100 determines that an approval process of the headquarters is skipped since the approval process table 1300 that corresponds to the headquarters has a record in which an item type “registration for service use”, approval skip “skipped”, and transfer “not transferred” are associated. The information processing apparatus 100 does not transmit an approval request to the apparatus for approval 202 of the headquarters and assumes that an approval has been given automatically.

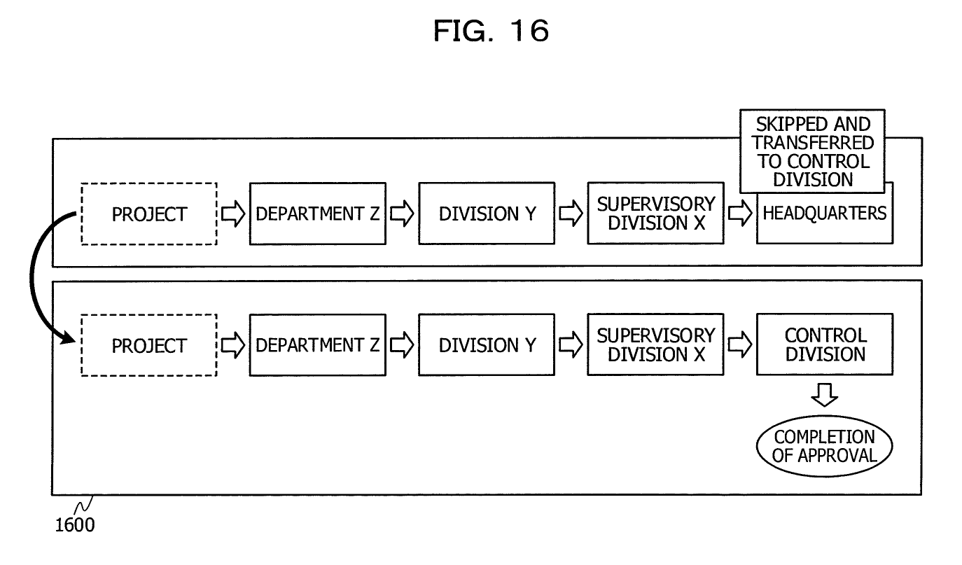

In this way, the information processing apparatus 100 can control an approval process of each of the organizations such as the department Z, the division Y, the supervisory division X, the headquarters, and the control division so that the approval flow 1500 is realized, without creating information indicative of the approval flow 1500. Next, FIG. 16 is described.

FIG. 16 is an explanatory view illustrating a specific example of an approval flow 1600 that corresponds to service use. In FIG. 16, the information processing apparatus 100 determines that an approval process of the department Z is executed since the approval process table 1000 that corresponds to the department Z has a record in which an item type “service use”, approval skip “not skipped”, and transfer “not transferred” are associated. The information processing apparatus 100 transmits an approval request to the apparatus for approval 202 of the department Z, causes an approving person of the department Z to determine whether or not to approve service use, and receives an approval result.

The information processing apparatus 100 determines that an approval process of the division Y is executed since the approval process table 1100 that corresponds to the division Y has a record in which an item type “service use”, approval skip “not skipped”, and transfer “not transferred” are associated. The information processing apparatus 100 transmits an approval request to the apparatus for approval 202 of the division Y, causes an approving person of the division Y to determine whether or not to approve service use, and receives an approval result.

The information processing apparatus 100 determines that an approval process of the supervisory division X is executed since the approval process table 1200 that corresponds to the supervisory division X has a record in which an item type “service use”, approval skip “not skipped”, and transfer “not transferred” are associated. The information processing apparatus 100 transmits an approval request to the apparatus for approval 202 of the supervisory division X, causes an approving person of the supervisory division X to determine whether or not to approve service use, and receives an approval result.

The information processing apparatus 100 determines that an approval process of the headquarters is skipped since the approval process table 1300 that corresponds to the headquarters has a record in which an item type “service use”, approval skip “skipped”, transfer “transferred”, and transfer destination “control division” are associated. Furthermore, the information processing apparatus 100 determines that an approval process of the control division is executed. The information processing apparatus 100 does not transmit an approval request to the apparatus for approval 202 of the headquarters and assumes that an approval has been given automatically. Furthermore, the information processing apparatus 100 transmits an approval request to the apparatus for approval 202 of the control division, causes an approving person of the control division to determine whether or not to approve service use, and receives an approval result.

In this way, the information processing apparatus 100 can control an approval process of each of the organizations such as the department Z, the division Y, the supervisory division X, the headquarters, and the control division so that the approval flow 1600 is realized, without creating information indicative of the approval flow 1600.

Although a case where an approval process table that corresponds to the project is not created, the present embodiment is not limited to this. For example, an approval process table that corresponds to the project may be created. The information processing apparatus 100 may cause a responsible person of the project to determine whether or not to give an approval upon issuance of an approval application for the department Z by an applicant belonging to the project. Next, FIG. 17 is described.

FIG. 17 is an explanatory view illustrating a specific example of transmission of an approval request. In FIG. 17, the information processing apparatus 100 transmits an approval request while referring to the organization table 400 and the user information table 500. For example, in a case where the information processing apparatus 100 transmits an approval request to the apparatus for approval 202 of the headquarters, the information processing apparatus 100 acquires an organization code of the headquarters from the organization table 400. The information processing apparatus 100 acquires an e-mail associated with the acquired organization code as an e-mail that corresponds to the apparatus for approval 202 of the headquarters from the user information table 500. The information processing apparatus 100 transmits the approval request by using the acquired e-mail.

Example 1 of Application of Information Processing Apparatus 100 to Change of Organization Structure

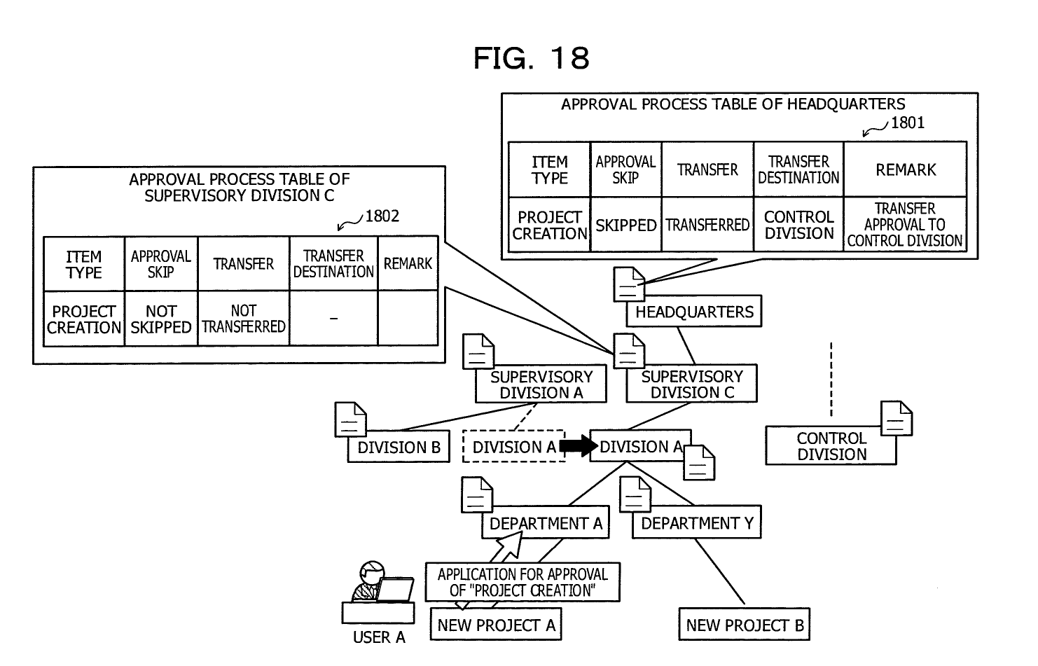

Next, an example 1 of application of the information processing apparatus 100 to a change of an organization structure is described with reference to FIG. 18.

FIG. 18 is an explanatory view illustrating the example 1 of application of the information processing apparatus 100 to a change of an organization structure. In the example illustrated in FIG. 18, a case where an organization structure changes so that the division A changes from an organization subordinate to the supervisory division A to an organization subordinate to a supervisory division C is described.

In this case, the information processing apparatus 100 can control execution of an approval process of each of the organizations in accordance with an approval policy in each of the organizations without updating an approval process table corresponding to each of the organizations. For example, an approval process table 1801 of the headquarters and an approval process table 1802 of the supervisory division C may not be updated in accordance with the change of the organization structure. Therefore, the information processing apparatus 100 can easily control execution of an approval process of each of the organizations and can keep an increase in the number of updated approval process tables small even in a case where an organization structure is changed.

Example 2 of Application of Information Processing Apparatus 100 to Change of Organization Structure

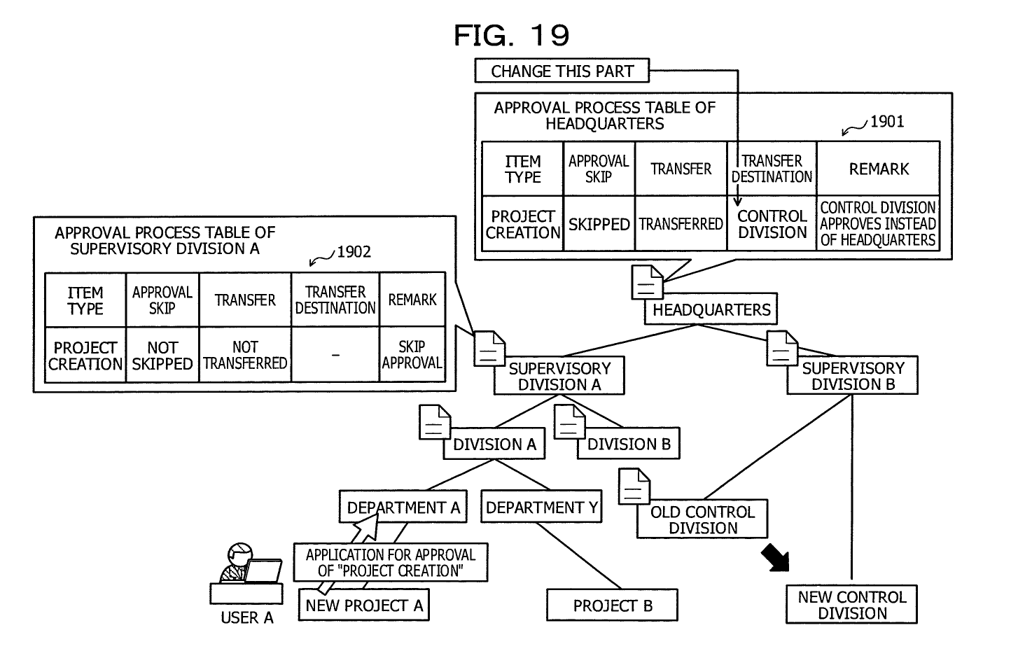

Next, an example 2 of application of the information processing apparatus 100 to a change of an organization structure is described with reference to FIG. 19.

FIG. 19 is an explanatory view illustrating the example 2 of application of the information processing apparatus 100 to a change of an organization structure. In the example illustrated in FIG. 19, a case where an organization structure changes so that an organization that manages each of the organizations changes from an old control division to a new control division is described.

In this case, the information processing apparatus 100 can control execution of an approval process of each of the organizations in accordance with an approval policy of each of the organizations without updating an approval process table including “not transferred” in the transfer field just by updating an approval process table including “transferred” in the transfer field. For example, the approval process table 1801 of the headquarters is changed, and the approval process table 1802 of the supervisory division A may not be changed in accordance with the change of the organization structure. Therefore, the information processing apparatus 100 can easily control execution of an approval process of each of the organizations and can keep the number of updated approval process tables relatively small even in a case where an organization structure is changed.

Flow of Approval Control Process

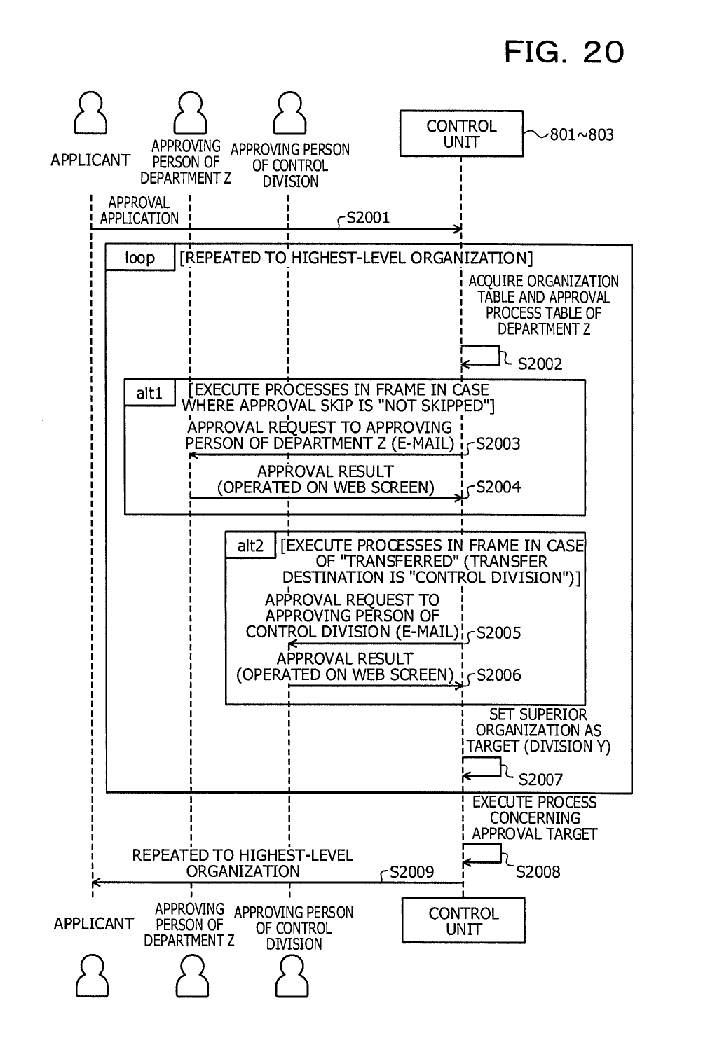

Next, a flow of an approval control process executed by the information processing apparatus 100 is described with reference to FIG. 20.

FIG. 20 is a sequence diagram illustrating a flow of the approval control process. In FIG. 20, the information processing apparatus 100 receives an approval application from the apparatus for request 201 of an applicant (Step S2001). The information processing apparatus 100 executes processes in the loop from an organization to which the approval application has been transmitted to a highest-level organization.

For example, in a case where the organization to which the approval application has been transmitted is the department Z, the information processing apparatus 100 acquires the organization table 400 and the approval process table of the department Z (Step S2002). Next, the information processing apparatus 100 executes processes in alt1 and processes in alt2 in a case where a predetermined condition is satisfied.

For example, in a case where the approval skip field of the approval process table of the department Z is “not skipped”, the information processing apparatus 100 transmits an approval request to the apparatus for approval 202 of an approving person of the department Z (Step S2003). Then, the information processing apparatus 100 receives an approval result from the apparatus for approval 202 of the approving person of the department Z (Step S2004).

For example, in a case where the transfer field of the approval process table of the department Z is “transferred”, the information processing apparatus 100 transmits an approval request to the apparatus for approval 202 of an approving person of the control division that is a transfer destination (Step S2005). Then, the information processing apparatus 100 receives an approval result from the apparatus for approval 202 of the approving person of the control division (Step S2006). In a case where there is an organization superior to the department Z, the information processing apparatus 100 sets this organization as a target of the processes in the loop (Step S2007).

When the processes in the loop are finished, the information processing apparatus 100 executes a process concerning an approval target in accordance with results of approval in the organizations such as the department Z and the control division (Step S2008). Then, the information processing apparatus 100 transmits a result of the process concerning the approval target to the apparatus for request 201 of the applicant (Step S2009).

Example of Procedure of Approval Control Process

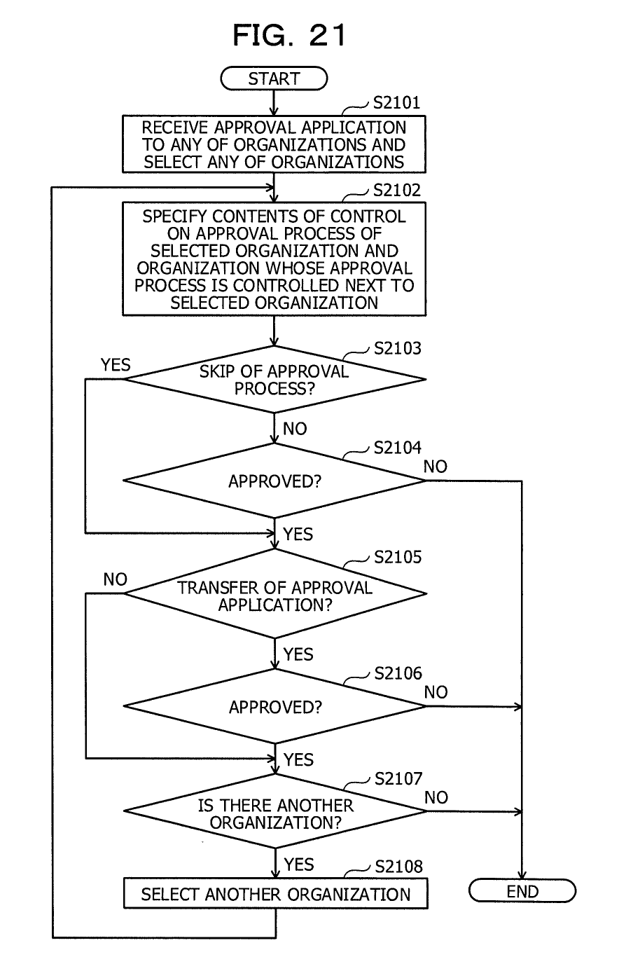

Next, an example of a procedure of an approval control process executed by the information processing apparatus 100 is described with reference to FIG. 21.

FIG. 21 is a flowchart illustrating an example of a procedure of the approval control process. In FIG. 21, the information processing apparatus 100 receives an approval application to any of the organizations and selects the organization (Step S2101).

Next, the information processing apparatus 100 specifies contents of control on an approval process of the selected organization and an organization whose approval process is controlled next to the selected organization by referring to an approval process table (Step S2102).

Then, the information processing apparatus 100 determines whether or not the contents of the control are skip of the approval process (Step S2103). In a case where the contents of the control are skip of the approval process (Yes in Step S2103), the information processing apparatus 100 proceeds to the process in Step S2105.

Meanwhile, in a case where the contents of the control are not skip of the approval process (No in Step S2103), the information processing apparatus 100 transmits the approval application to the apparatus for approval 202 corresponding to the selected organization and determines whether or not an approval target has been approved (Step S2104). In a case where the approval target has not been approved (No in Step S2104), the information processing apparatus 100 finishes the approval control process.

Meanwhile, in a case where the approval target has been approved (Yes in Step S2104), the information processing apparatus 100 determines whether or not the contents of the control are transfer of the approval application (Step S2105). In a case where the contents of the control are not transfer of the approval application (No in Step S2105), the information processing apparatus 100 proceeds to the process in Step S2107.

Meanwhile, in a case where the contents of the control are transfer of the approval application (Yes in Step S2105), the information processing apparatus 100 transmits the approval application to the apparatus for approval 202 corresponding to the transfer destination and determines whether or not an approval target has been approved (Step S2106). In a case where the approval target has not been approved (No in Step S2106), the information processing apparatus 100 finishes the approval control process.

Meanwhile, in a case where the approval target has been approved (Yes in Step S2106), the information processing apparatus 100 determines whether or not there is another organization whose approval process is controlled next to the selected organization (Step S2107). In a case where there is another organization (Yes in Step S2107), the information processing apparatus 100 selects the other organization (Step S2108) and returns to the process in Step S2102.

Meanwhile, in a case where another organization is not present (No in Step S2107), the information processing apparatus 100 finishes the approval control process. In this way, the information processing apparatus 100 can control an approval process of one or more organizations for approving an approval target and control an approval process of a transfer destination if there is a transfer destination.

As described above, the information processing apparatus 100 can receive an approval application. Upon receipt of the approval application, the information processing apparatus 100 can sequentially control an approval process of each of one or more organizations among a plurality of organizations based on contents stored in the storage unit 800. In this way, the information processing apparatus 100 may specify how to control execution of an approval process of each of the organizations without creating information on an approval flow for each organization using a service. Therefore, the information processing apparatus 100 can easily control execution of an approval process of each of the organizations and easily manage execution of an approval process of each of the organizations.

The information processing apparatus 100 can receive an approval application generated for any of the plurality of organizations. The information processing apparatus 100 can control at least an approval process of the organization based on contents stored in the storage unit 800. The information processing apparatus 100 can repeat control of an approval process of an organization whose approval process is controlled next to the last organization whose approval process is controlled in a case where the organization whose approval process is controlled next to the last organization exists. Therefore, the information processing apparatus 100 can easily sequentially control execution of an approval process from an organization to which an approval application is transmitted first to a highest-level organization.

In a case where the information processing apparatus 100 controls an approval process of any of the organizations based on contents stored in the storage unit 800, the information processing apparatus 100 can further control an approval process of another organization. Therefore, the information processing apparatus 100 can perform control so that an approval process of a predetermined organization is executed regardless of a hierarchical relationship among the organizations. For example, the information processing apparatus 100 allows the control division to easily manage each of the organizations regardless of the hierarchical relationship among the organizations. Furthermore, the information processing apparatus 100 can cause another organization to perform an approval process of any of the organizations instead regardless of the hierarchical relationship among the organizations.

The information processing apparatus 100 can receive an approval application indicative of a type of approval target. The information processing apparatus 100 can sequentially control an approval process of each of one or more organizations among a plurality of organizations based on first information and second information that are stored in the storage unit 800 and that correspond to the type indicated by the approval application. Therefore, the information processing apparatus 100 can switch how to control execution of an approval process of each of the organizations depending on the type of approval target.

The information processing apparatus 100 can use first information indicative of contents of control of omitting execution of an approval process of any of a plurality of organizations as first information indicative of contents of control on the approval process of the organization. Therefore, the information processing apparatus 100 can omit execution of an approval process of any of the organizations and thereby keep an increase in burden on an approving person of the organization related to the approval process small.

The information processing method described in the present embodiment can be realized by causing a computer such as a personal computer or a work station to execute a program prepared in advance. This program is recorded in a computer-readable recording medium such as a hard disk, a flexible disc, a CD-ROM, an MO, or a DVD and is read out from the recording medium by the computer. This program may be distributed over a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to execute a process, the process including:
receiving a request for an approval process for a specified organization included in a plurality of organizations, the approval process corresponding to a specified approval event included in a plurality of approval events;
executing approval process based on first information stored in a storage unit, the first information indicating a plurality of contents, for each of the plurality of organizations, to which each of the plurality of approval events correspond; and
executing, after the approval process, a following approval process for a higher organization of the specified organization, indicated by second information stored in the second storage unit, based on the first information, the second information indicating a hierarchy relationship of the plurality of organizations.

2. The information processing apparatus according to claim 1, wherein
the first information includes contents of control on an approval process of another organization that manages the approval process and that is different from the plurality of organizations; and wherein
the process further comprises:
executing, after the approval process, an approval process for the another organization when the contents of control on the approval process of the another organization indicates that the approval process for the another organization is needed.

3. The information processing apparatus according to claim 1, wherein
the process further comprises:
skipping the approval process for the specified organization when the first information, corresponding to the specified organization and the specified approval event, indicates that the approval process for the specified organization is not needed for the specified approval event.

4. An information processing method executed by a computer, the information processing method comprising:
receiving a request for an approval process for a specified organization included in a plurality of organizations, the approval process corresponding to a specified approval event included in a plurality of approval events;
executing approval process based on first information stored in a storage unit, the first information indicating a plurality of contents, for each of the plurality of organizations, to which each of the plurality of approval events correspond; and
executing, after the approval process, a following approval process for a higher organization of the specified organization, indicated by second information stored in the second storage unit, based on the first information, the second information indicating a hierarchy relationship of the plurality of organizations.

5. A non-transitory computer-readable storage medium storing a program that causes a computer to execute a process, the process comprising:
receiving a request for an approval process for a specified organization included in a plurality of organizations, the approval process corresponding to a specified approval event included in a plurality of approval events;
executing approval process based on first information stored in a storage unit, the first information indicating a plurality of contents, for each of the plurality of organizations, to which each of the plurality of approval events correspond; and
executing, after the approval process, a following approval process for a higher organization of the specified organization, indicated by second information stored in the second storage unit, based on the first information, the second information indicating a hierarchy relationship of the plurality of organizations.
